(19) United States
(12) Patent Application Publication
(10) Pub. No.: US 2022/0321395 A1
(43) Pub. Date: Oct. 6, 2022

(54) MANAGING NETWORK EVENT DATA IN A TELECOMMUNICATIONS NETWORK

(71) Applicant: Telefonaktiebolaget LM Ericsson (publ), Stockholm (SE)

(72) Inventors: M Saravanan, CHENNAI (IN); Meenakshi Sundaram Govindassamy, CHENNAI (IN)

(73) Assignee: Telefonaktiebolaget LM Ericsson (publ), Stockholm (SE)

(21) Appl. No.: 17/610,771

(22) PCT Filed: May 15, 2019
(86) PCT No.: PCT/IN2019/050389

§ 371 Date: Nov. 12, 2021

(51) Int. Cl. H04L 41/069; H04L 41/0686; H04L 41/16; H04L 41/02

(52) U.S. Cl. CPC H04L 41/069; H04L 41/0686; H04L 41/16; H04L 41/024

(57) ABSTRACT

Managing network event data in a telecommunications network A method (200) is disclosed for managing network event data in a telecommunications network, wherein a network event is associated with a plurality of network event data fields, and wherein the telecommunications network comprises a data storage facility for network event data, the data storage facility comprising a plurality of storage functions. The method comprises obtaining queries submitted to the data storage facility (210) and, for a network event data field, determining a frequency with which data in the network event data field is required in order to respond to the obtained queries (220) and using a trained machine learning model to map the determined frequency to a value of a selection parameter for the network event data field (230). The method further comprises performing at least one of (240) storing data in the network event data field in a storage function in the data storage facility, migrating data in the network event data field between storage functions in the data storage facility or deleting data in the network event data field from a storage function in the data storage facility in accordance with the value of the selection parameter. Also disclosed are a method (400) of training a machine learning model and apparatus and a computer program product for carrying out methods for managing network event data and training a machine learning model.

### TECHNICAL FIELD

The present disclosure relates to a method for managing network event data in a telecommunications network, wherein a network event is associated with a plurality of network event data fields, and wherein the telecommunications network comprises a data storage facility for network event data, the data storage facility comprising a plurality of storage functions. The present disclosure also relates to a method for training a machine learning model for use in a method for managing network event data in a telecommunications network. The present disclosure also relates to apparatus and to a computer program and a computer program product configured, when run on a computer to carry out methods for managing network event data and training a machine learning model.

### BACKGROUND

In a telecommunication network, an event is generated each time a transaction occurs, including for example a user making a call, topping up credit or moving from one location to another, etc. These events are stored in storage which is classed as Warm, Cold or Hot, according to the availability of the stored data. Event data is stored for a variety of reasons including handling of system or customer issues or queries, responding to legal enquiries, or for analytical, data mining or machine learning purposes. The number of users connected to telecommunication networks continues to increase, and a single customer is now often subscribed to multiple services. Additionally, mobile usage of telecommunication network customers has significantly evolved, with the advent pf smartphones driving an exponential increase in data usage. Consequently, billions of events are now generated in telecommunication networks every day, with this figure set to increase following the introduction of 5G and its facilitating of massive Internet of Things (IoT) deployment. Storage of these billions of network events is a significant challenge, and is complicated by the need to process, maintain and support both regular and irregular queries for an increasingly long period of time after the events have been generated. The introduction of Warm/Cold/Hot storage techniques is intended to assist with these challenges, although retrieving data from cold storage remains a time consuming process that can delay query response. In addition, managing when to transition data from Warm to Cold storage remains problematic, with the challenge of balancing the need to provide efficient storage with that of maintaining accessibility of the data.

Existing storage methods employ Hot/Warm/Cold storage functions based on access patterns. For example when a user triggers a query, an event related to that query is moved to Hot storage, and if the event is not accessed for a certain time period then the event is moved to Warm storage and after some time it is moved to Cold storage or archive, which is usually implemented as tape drives. This process results in high Total Cost of Ownership (TCO) in order to store, maintain and retrieve the events over long time periods. Older data stored in the tape archives is very difficult to restore in order to support queries, meaning the complexity level of using such data is high. Retrieval from the tape archives is also time consuming, meaning many queries cannot be addressed in an acceptable time frame. One example of such retrieval is legal enquiries which may require call records going back several years. Retrieving such records within an acceptable delay is extremely difficult.

The scale of telecommunication event data also poses significant challenges, independent of the need for efficient access to the data. Telecommunication data can scale to over 14 TB in just over a month when a million customers participate in calls. Translation schemes may be effective at reducing the storage space for data that is live in a database in Hot or Warm storage, but once the data is archived as parquets, translation makes a negligible gain in the storage space saved. Apache Parquet 2.0, available from http://parquet.apache.org, is one of many storage formats that may be used for archiving telecommunications data. Another storage format frequently used is Avro, which has been developed within Apache's Hadoop project.

Apache Parquet 2.0 is based on a columnar storage format and is highly efficient in compressing data along with many field-level operations. These operations include reducing the space required by repetitive data using run-length encoding, reducing number of bits to store numbers by assessing the maximum number in the field, dictionary encoding, prefix encoding, and so on. Charging events represent the vast majority of events generated in a telecommunications system. The complicated nesting of fields such as arrays and other structures in charging event data can lead to over 1000 fields per charging record.

### SUMMARY

It is an aim of the present disclosure to provide a method, apparatus and computer readable medium which at least partially address one or more of the challenges discussed above.

According to a first aspect of the present disclosure, there is provided a method for managing network event data in a telecommunications network, wherein a network event is associated with a plurality of network event data fields, and wherein the telecommunications network comprises a data storage facility for network event data, the data storage facility comprising a plurality of storage functions. The method comprises obtaining queries submitted to the data storage facility, and, for a network event data field, determining a frequency with which data in the network event data field is required in order to respond to the obtained queries and using a trained machine learning model to map the determined frequency to a value of a selection parameter for the network event data field. The method further comprises performing at least one of storing data in the network event data field in a storage function in the data storage facility, migrating data in the network event data field between storage functions in the data storage facility, or deleting data in the network event data field from a storage function in the data storage facility, in accordance with the value of the selection parameter.

According to examples of the present disclosure, the network event data may comprise data relating to a plurality of different network event types, including fault events, alarm events, performance events, billing events etc.

According to examples of the present disclosure, obtaining queries submitted to the data storage facility may comprise obtaining queries submitted during an analysis time window comprising a plurality of time slots. According to such examples, determining a frequency with which data in the network event data field is required to respond to the obtained queries may comprise, for a time slot in an analysis time window, accumulating obtained queries submitted within the time slot, extracting network event data fields required to respond to the accumulated queries, and adding the number of times the network event data field appears in the extracted network event data fields to a time slot frequency count for the network event data field.

According to examples of the present disclosure, determining a frequency with which data in the network event data field is required to respond to the obtained queries may further comprise assembling time slot frequency counts for the network event data field from time slots in the analysis time window into a frequency vector for the network event data field during the analysis time window.

According to examples of the present disclosure, the analysis time window may be a sliding time window of fixed size and divided into equal time slots of fixed size. The analysis time window may correspond to a retention period for a storage function in the data storage facility. The trained machine learning model may map the frequency vector to the selection parameter.

According to examples of the present disclosure, the selection parameter value may indicate a relative importance of the network event data field with respect to responding to queries submitted to the data storage facility, and the trained machine learning model may map the determined frequency to a value of the selection parameter for the network event data field such that a higher frequency maps to a value indicating greater importance.

According to examples of the present disclosure, using a trained machine learning model to map the determined frequency to a value of a selection parameter for the network event data field may comprise using the trained machine learning model to map the determined frequency to a dynamic value of the selection parameter, and generating a definitive value of the selection parameter by combining the frequency based value of the selection parameter with a static value of the selection parameter.

According to examples of the present disclosure, the static value may be preconfigured for the network event data fields on the basis of at least one of legal requirements, regulatory requirements, business requirements etc.

According to examples of the present disclosure, the selection parameter may comprise a binary value, and combining the dynamic value of the selection parameter with a static value of the selection parameter may comprise performing a logical OR operation on the dynamic value of the selection parameter and the static value of the selection parameter.

According to examples of the present disclosure, the trained machine learning model may be trained to map the determined frequency to a selection parameter for the network event data field according to the objective function:

$${Minimise}_{\vec{x}} \vec{c} \cdot \vec{x} \\ Subject to \frac{{\sum }_{q ∈ {Q}_{T}} g ( q , \vec{x} )}{\vert {Q}_{T} \vert} \geq C \\ Where g ( q , \vec{x} ) = \{ \begin{matrix}1 if A ( q ) - B ( \vec{x} ) = 0 , \\ 0 otherwise\end{matrix}$$

wherein:

\vec{c} comprises a vector of storage capacity occupied by network event data fields;

\vec{x} comprises a vector of selection parameter values for network event data fields;

Q_{T} comprises a set of queries submitted over an analysis time window T;

A(q) comprises a set of network event data fields required by a query q; and

B(\vec{x}) comprises the set of network event data fields having a particular selection parameter value according to \vec{x};

C comprises a threshold for queries for which the required network data event fields have the particular selection parameter value.

According to examples of the present disclosure, the particular selection parameter value may correspond to an availability of the data in the corresponding network event data fields, such that if A(q)−B(\vec{x})=0 for a particular query q, this indicates that all of the network event data fields that are required by query q are available according to the vector \vec{x}.

According to examples of the present disclosure, the particular selection parameter value may indicate an availability of the network event data field in the data storage facility.

According to examples of the present disclosure, the availability may indicate presence of the data in the network event data field in the storage facility, or may indicate presence of the data in the network event data field in a particular storage function of the data storage facility. The particular storage function may comprise a function associated with particular read/write capabilities. The particular read/write capabilities may include a speed of read/write operations, and the particular storage function may comprise a short or medium term storage function. The trained machine learning model may map the determined frequency to a value of the selection parameter such that a higher frequency maps to a selection parameter value associated with greater availability of the data in the network event data field.

According to examples of the present disclosure, storing data in the network event data field in a storage function in the data storage facility in accordance with the selection parameter may comprise selecting a storage function for the network event data field in accordance with the selection parameter, and initiating storage of data in the network event data field in the selected storage function.

According to examples of the present disclosure, migrating data in the network event data field between storage functions in the data storage facility in accordance with the selection parameter may comprise selecting a storage function for the network event data field in accordance with the selection parameter, and, on occurrence of a migration trigger, initiating migration of data in the network event data field to the selected storage function.

According to examples of the present disclosure, as discussed above, the storage functions may have particular read/write capabilities, and selection of a storage function in accordance with the selection parameter may comprise selecting a storage function having faster read/write capabilities for those network event data fields having a particular value of the selection parameter (the value being associated with a greater frequency of requirement for responding to obtained queries).

According to examples of the present disclosure, the migration trigger may comprise expiry of the analysis time window.

According to examples of the present disclosure, deleting data in the network event data field from a storage function in the data storage facility in accordance with the selection parameter may comprise generating an overview selection parameter value by combining selection parameter values over a plurality of analysis time windows, and determining whether to delete data in the network event data field from a storage function in the data storage facility on the basis of the overview selection parameter value.

According to examples of the present disclosure, the selection parameter may comprise a binary value, and combining selection parameter values over a plurality of analysis time windows may comprise performing a logical OR operation on the selection parameter values over a plurality of analysis time windows. According to examples of the present disclosure, this may ensure that only those network event data fields that have never had a positive selection parameter value during the plurality of analysis time windows will be selected for deletion from the storage function.

According to examples of the present disclosure, the plurality of analysis time windows may be sufficient to ensure that the total time covered by the plurality of analysis time windows fulfils certain criteria applicable to a particular service or service provider. For example, the plurality of analysis time windows may be sufficient to ensure that the total time covered by the plurality of analysis time windows is at least one calendar year, so as to account for variations in the nature of queries that may be submitted over a year long period. In some examples, the total time covered by the plurality of analysis time windows may comprise between 1.5 and 2 years.

According to examples of the present disclosure, the method may further comprise generating a vector of selection parameter values for a plurality of network event data fields, and determining whether the generated vector of selection parameter values satisfies a criterion representing a threshold for queries for which the required network data event fields have a particular selection parameter value.

According to examples of the present disclosure, the particular selection parameter value may be associated with availability of the data in the network event data fields, such that the criterion represents a threshold for queries for which the required network event data fields are available.

According to examples of the present disclosure, the method may further comprise, if the generated vector of selection parameter values does not satisfy the criterion, retraining the machine learning model, and using the retrained machine learning model to map the determined frequency to a value of a selection parameter for the network event data field.

According to examples of the present disclosure, retraining the machine learning model may comprise performing the steps of any of the examples directed to a method for training a machine learning model, set out below.

According to examples of the present disclosure, the method may further comprise, for data in network event data fields that are stored in a storage function of the data storage facility that is associated with a first set of read/write capabilities, identifying data for migration to a storage function of the data storage facility that is associated with a second set of read/write capabilities on the basis of at least one of frequency of access requests, and storage capacity occupied by the data in the network event data fields, and initiating migration of the identified data to the storage function of the data storage facility that is associated with the second set of read/write capabilities.

According to examples of the present disclosure, identifying data for migration to a storage function of the data storage facility that is associated with a second set of read/write capabilities on the basis of at least one of frequency of access requests and storage capacity occupied by the data in the network event data fields may comprise preferentially identifying data having a highest or lowest frequency of access requests, and maximising a total storage capacity occupied by the identified data up to a maximum available storage capacity in the storage function of the data storage facility that is associated with the second set of read/write capabilities.

According to examples of the present disclosure, the network events of the network event data may comprise charging events.

According to another aspect of the present disclosure, there is provided a method for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions. The method for training a machine learning model comprises obtaining queries submitted to the data storage facility and, for each of a plurality of network event data fields, determining a frequency with which data in the network event data field is required in order to respond to the obtained queries. The method further comprises calculating a threshold frequency value, labelling the network event data fields with a selection parameter value generated on the basis of the determined frequencies and the threshold frequency value, and applying a machine learning algorithm to a training data set comprising the labelled network event data fields and determined frequencies to generate a model for mapping a determined frequency for a network event data field to a value of a selection parameter for the network event data field.

According to examples of the present disclosure, the selection parameter value may be binary and labelling the network event data fields may comprise setting the selection parameter value to 1 for all network event data fields having a frequency over the threshold frequency. According to examples of the present disclosure, the method may comprise generating vectors of frequencies for time slots over an analysis time window, which may for example be a retention time for a storage function in the data storage facility. In other examples the vector may comprise frequencies for multiple analysis time windows.

According to examples of the present disclosure, calculating a threshold frequency value may comprise:

generating a vector:

\vec{u}=[Σ\vec{v}⁽¹⁾,Σ\vec{v}⁽²⁾,Σ\vec{v}⁽³⁾, . . . ,Σ\vec{v}⁽ⁿ⁾],

wherein:

\vec{v}⁽ⁱ⁾ comprises a vector of frequencies for a plurality of time slots within an analysis time window for a network event data field i, and calculating the threshold frequency value using the expression:

$${v}_{θ} = {argmin}_{v} \frac{\sum \{ u ∈ \vec{u} \vert u \geq v \}}{\sum \vec{u}} \geq C$$

wherein:

v_{θ} comprises the threshold frequency value; and

C comprises a threshold for queries for which the required network data event fields have a particular selection parameter value.

According to examples of the present disclosure, the method may further comprise determining whether the generated model conforms to a constraint by generating a vector \vec{y} of mapped selection parameter values using the generated model and determining whether the generated vector satisfies the expression:

$$\frac{\vec{u} \cdot \vec{y}}{\sum \vec{u}} \geq C$$

According to examples of the present disclosure, the machine learning algorithm may comprise at least one of a Random Forrest algorithm or a Logistic Regression algorithm.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to the previous aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a previous aspect of the present disclosure.

According to another aspect of the present disclosure, there is provided apparatus for managing network event data in a telecommunications network, wherein a network event is associated with a plurality of network event data fields, and wherein the telecommunications network comprises a data storage facility for network event data, the data storage facility comprising a plurality of storage functions. The apparatus comprises a processor and a memory, the memory containing instructions executable by the processor such that the apparatus is operable to obtain queries submitted to the data storage facility, and for a network event data field, determine a frequency with which data in the network event data field is required in order to respond to the obtained queries and use a trained machine learning model to map the determined frequency to a value of a selection parameter for the network event data field. The apparatus is further operable to perform at least one of storing data in the network event data field in a storage function in the data storage facility, migrating data in the network event data field between storage functions in the data storage facility, or deleting data in the network event data field from a storage function in the data storage facility, in accordance with the value of the selection parameter.

According to examples of the present disclosure, the apparatus may be further operable to carry out a method according to any one of the preceding aspects or examples of the present disclosure.

According to another aspect of the present disclosure, there is provided apparatus for managing network event data in a telecommunications network, wherein a network event is associated with a plurality of network event data fields, and wherein the telecommunications network comprises a data storage facility for network event data, the data storage facility comprising a plurality of storage functions. The apparatus is adapted to obtain queries submitted to the data storage facility, and for a network event data field, determine a frequency with which data in the network event data field is required in order to respond to the obtained queries and use a trained machine learning model to map the determined frequency to a value of a selection parameter for the network event data field. The apparatus is further adapted to perform at least one of storing data in the network event data field in a storage function in the data storage facility, migrating data in the network event data field between storage functions in the data storage facility, or deleting data in the network event data field from a storage function in the data storage facility, in accordance with the value of the selection parameter.

According to examples of the present disclosure, the apparatus may be further adapted to carry out a method according to any one of the preceding aspects or examples of the present disclosure.

According to another aspect of the present disclosure, there is provided apparatus for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions. The apparatus comprises a processor and a memory, the memory containing instructions executable by the processor such that the apparatus is operable to obtain queries submitted to the data storage facility and for each of a plurality of network event data fields, determine a frequency with which data in the network event data field is required in order to respond to the obtained queries. The apparatus is further operable to calculate a threshold frequency value, label the network event data fields with a selection parameter value generated on the basis of the determined frequencies and the threshold frequency value, and apply a machine learning algorithm to a training data set comprising the labelled network event data fields and determined frequencies to generate a model for mapping a determined frequency for a network event data field to a value of a selection parameter for the network event data field.

According to examples of the present disclosure, the apparatus may be further operable to carry out a method according to any one of the preceding aspects or examples of the present disclosure.

According to another aspect of the present disclosure, there is provided apparatus for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions. The apparatus is adapted to obtain queries submitted to the data storage facility and for each of a plurality of network event data fields, determine a frequency with which data in the network event data field is required in order to respond to the obtained queries. The apparatus is further adapted to calculate a threshold frequency value, label the network event data fields with a selection parameter value generated on the basis of the determined frequencies and the threshold frequency value, and apply a machine learning algorithm to a training data set comprising the labelled network event data fields and determined frequencies to generate a model for mapping a determined frequency for a network event data field to a value of a selection parameter for the network event data field. According to examples of the present disclosure, the apparatus may be further adapted to carry out a method according to any one of the preceding aspects or examples of the present disclosure.

### BRIEF DESCRIPTION OF THE DRAWINGS

For a better understanding of the present invention, and to show more clearly how it may be carried into effect, reference will now be made, by way of example, to the following drawings, in which:

FIG. 1 illustrates a high level architecture which may be used to implement examples of the present disclosure;

FIG. 2 is a flow chat illustrating process steps in a method for managing network event data in a telecommunications network;

FIGS. 3a to 3d show a flow chat illustrating process steps in another example of method for managing network event data in a telecommunications network;

FIG. 4 is a flow chart illustrating process steps in a method for training a machine learning model;

FIG. 5 is a block diagram illustrating functional modules in an apparatus;

FIG. 6 is a block diagram illustrating functional modules in another example of apparatus;

FIG. 7 is a block diagram illustrating functional modules in another example of apparatus;

FIG. 8 is a block diagram illustrating functional modules in another example of apparatus;

FIG. 9 illustrates an architecture for an apparatus implementing a Frequent Field Selection algorithm;

FIG. 10 illustrates a Request Frequency Monitor;

FIG. 11 illustrates an Optimised Field Selector;

FIG. 12 illustrates a Data Storage Processor;

FIG. 13 illustrates a case study;

FIGS. 14a to 14d illustrate operation of an FFS engine according to the case study of FIG. 13;

FIG. 15 illustrates storage efficiency as demonstrated in the case study of FIG. 13; and

FIGS. 16 and 17 illustrate another case study.

### DETAILED DESCRIPTION

As discussed above, event data is currently managed such that an entire event is transitioned between Hot, Warm and cold storage functions on the basis of access patterns. In practice, only very few fields of an event are required in order to satisfy the vast majority of queries, and examples of the present disclosure therefore propose to archive only a subset of the data that is sufficient for a given business use case. An objective of examples of the present disclosure is to find the optimal subset of fields that would suffice for a given use case. As the data in question is semi-structured, feature selection methods designed for structured data are not appropriate. A straightforward field-selection machine learning model could be structured as a multi-label problem comprising features setting out a frequency of requests for each field and the labels denoting whether or not the fields are included in a particular storage function. However, such an approach, with its rigid field structure, does not scale well. That is, no modification can be made on the schema without abandoning the trained model. Schema fields can change over time, new fields can be added and others may be removed, and small changes can also occur in structure. The above discussed model does not have the flexibility to accommodate such changes.

The set of fields in a telecommunication database can be considered sufficient if it could answer all queries in its lifetime. This hard constraint prevents removing any field from the database, as the universe of queries can encompass all fields in the schema. However, the constraint can be softened by answering only a proportion, C, of such queries, say C=90%, over a period T. The problem can then be phrased as how to select a subset of fields from a schema such that C proportion of incoming queries are satisfied.

Examples of the present disclosure propose a method that enables selection of fields for storage functions based on frequency of query access. A proposed Frequent Field Selection (FFS) technique employs a machine learning model to introduce the learning aspect in this process. The model learns the fields of an event that are accessed to respond to queries (specific query processing) over a long period of time. The model uses this learning to find fields of interest in event data and propose to store information in such fields in the Warm storage function rather than the Cold storage function. Over a period of time, the model may additionally manage the data in the cold archives to avoid the huge storage of unnecessary events and data fields. Examples of the proposed model may be capable of adapting to variations in both data and queries, through introduction of new features or depreciation of existing features. Examples of the present disclosure propose a data migration mechanism which may combine query frequency information with properties of the Hot/Warm/Cold storage to optimise selection of events and event fields for storage in particular functions.

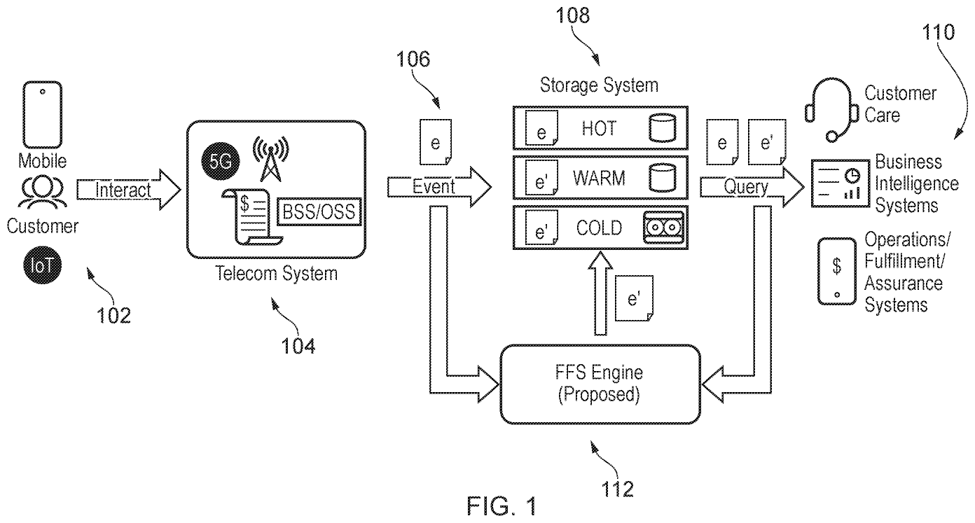

A high level architecture which may be used to implement examples of the present disclosure is illustrated in FIG. 1. Referring to FIG. 1, customers and IoT devices 102 interact with the Operations Support System (OSS), Business Support System (BSS) and other systems in a telecommunication network 104, and in the process multiple events 106 are generated. Events 106 are stored in a storage system 108 which comprises Hot storage for frequently accessed information, Warm storage for occasionally accessed information and Cold storage for sporadically accessed information. Event information is accessed by systems 110 including Customer Care, Business Intelligence and Reporting systems, operational/fulfillment/assurance systems etc. A Frequent Field Selection (FFS) Engine 112 obtains events and queries from the systems 110 and performs methods according to examples of the present disclosure to manage network event data such that data in particular fields is stored in an appropriate storage function.

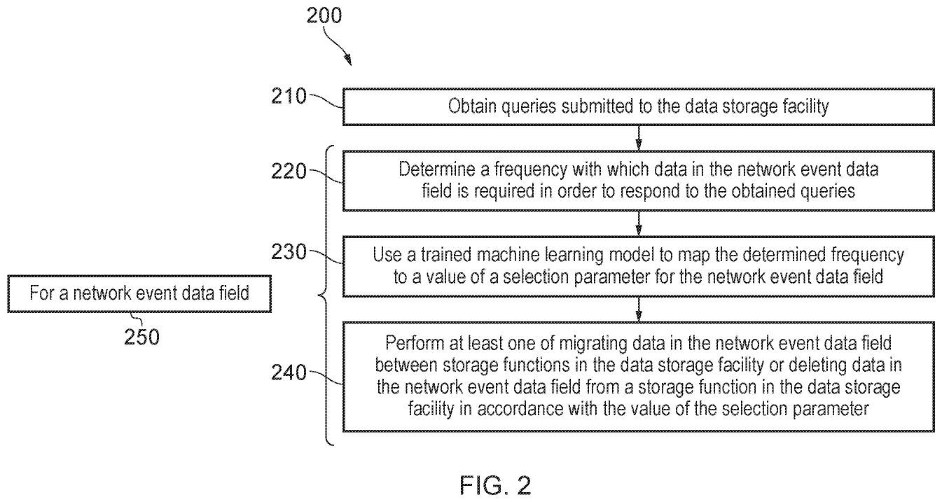

FIG. 2 is a flow chat illustrating a method for managing network event data in a telecommunications network according to an example of the present disclosure, wherein a network event is associated with a plurality of network event data fields, and wherein the telecommunications network comprises a data storage facility for network event data, the data storage facility comprising a plurality of storage functions. The method may be performed in any appropriate apparatus or function of the telecommunication network or in communication with the telecommunication network. In one example, the apparatus may comprise an FFS engine as discussed above. Referring to FIG. 2, in a first step 210 the method comprises obtaining queries submitted to the data storage facility. The method then comprises, for a network event data field as illustrated at 250, determining a frequency with which data in the network event data field is required in order to respond to the obtained queries in step 2202 and using a trained machine learning model to map the determined frequency to a value of a selection parameter for the network event data field in step 230. In step 240, the method comprises performing at least one of storing data in the network event data field in a storage function in the data storage facility, migrating data in the network event data field between storage functions in the data storage facility, or deleting data in the network event data field from a storage function in the data storage facility in accordance with the value of the selection parameter.

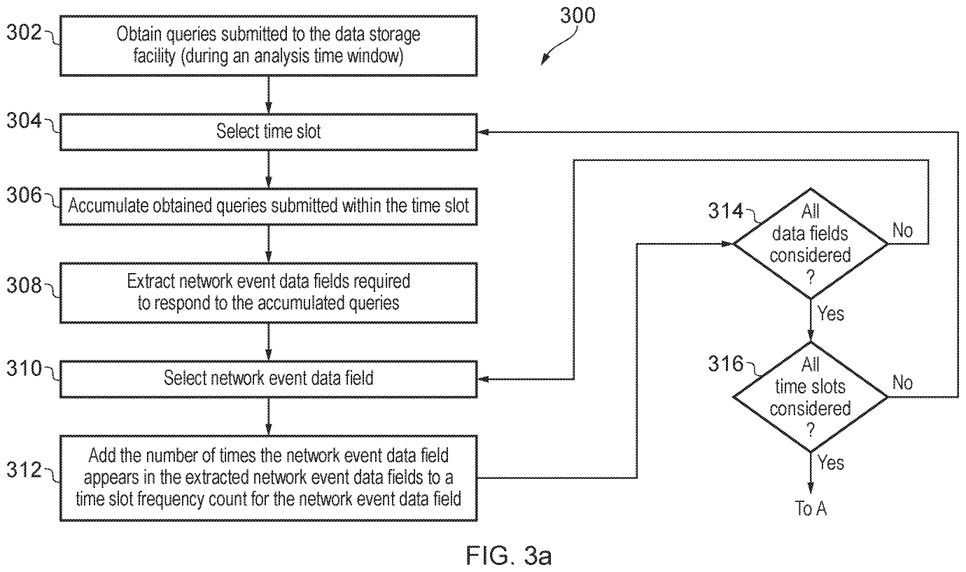

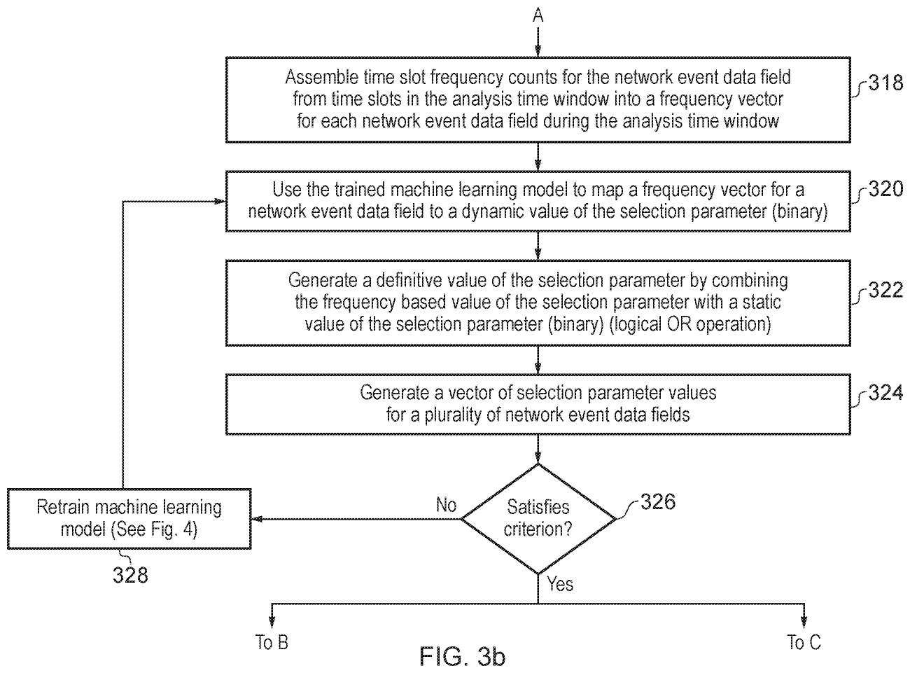

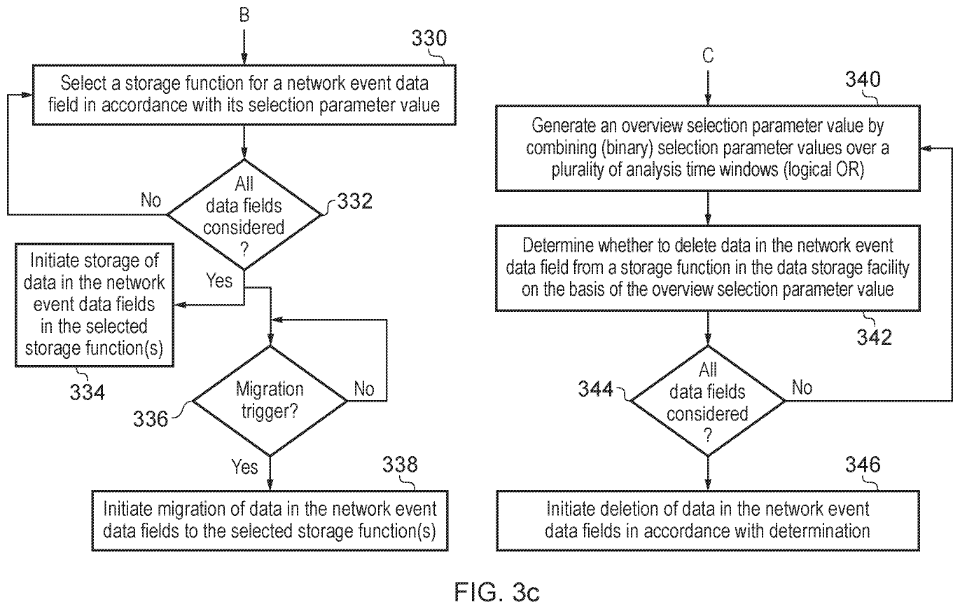

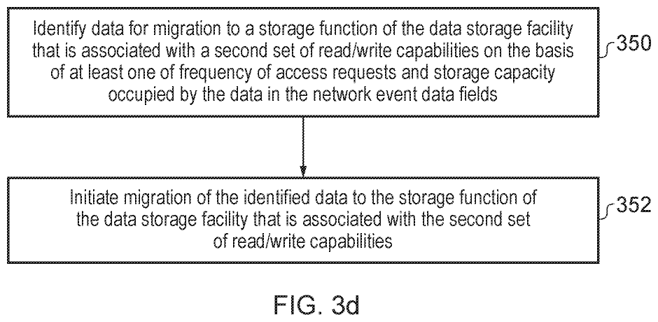

FIGS. 3a to 3d show flow charts illustrating process steps in a further example of method 300 for managing network event data in a telecommunications network, wherein a network event is associated with a plurality of network event data fields, and wherein the telecommunications network comprises a data storage facility for network event data, the data storage facility comprising a plurality of storage functions. The steps of the method 300 illustrate one example way in which the steps of the method 200 may be implemented and supplemented in order to achieve the above discussed and additional functionality. As for the method 200 discussed above, the method 300 may be performed in any appropriate apparatus or function of the telecommunication network or in communication with the telecommunication network. For the purposes of illustration, the method 300 is described below as being carried out by an FFS engine.

The network event data managed according to the method 100 or 300 may comprise data relating to a plurality of different network event types, including fault events, alarm events, performance events, billing events, charging events etc. Referring initially to FIG. 3a, the FFS engine first obtains queries submitted to the data storage facility in step 302. This may comprise obtaining queries submitted during an analysis time window comprising a plurality of time slots. It will be appreciated that the analysis time window may be a sliding time window of fixed size and divided into equal time slots of fixed size. The analysis time window may correspond to a retention period for a storage function in the data storage facility.

In step 304, the FFS engine selects a time slot and, for that time slot in the analysis time window, the FFS engine accumulates obtained queries submitted within the time slot in step 306 and extracts network event data fields required to respond to the accumulated queries instep 308. In step 310, the FFS engine selects a network event data field and, in step 312, the FFS engine adds the number of times the network event data field appears in the extracted network event data fields to a time slot frequency count for the network event data field. In step 314, the FFS engine checks whether all data fields been considered within the current time slot. If not, the FFS engine returns to step 310 to select a new network event data field, and repeats this process until all network event data fields have been considered within the current time slot. Once all network event data fields have been considered in the current time slot, the FFS engine checks, in step 316 whether all time slots within the analysis time window have been considered. If not, the FFS engine returns to step 304 to select a new time slot and repeat steps 306 to 314, until all time slots within the analysis time window have been considered.

Referring now to FIG. 3b, once all time slots in the analysis time window have been considered, the FFS engine assembles, in step 318, time slot frequency counts for network event data fields from time slots in the analysis time window into a frequency vector for each network event data field during the analysis time window. A frequency vector thus contains entries corresponding to the frequency counts for a particular network event data field for each time slot.

In step 320, the FFS engine uses a trained machine learning model to map the frequency vector for each network event data field to a dynamic value of a selection parameter. The selection parameter value indicates a relative importance of the network event data field with respect to responding to queries submitted to the data storage facility, and the trained machine learning model may map the determined frequency to a value of the selection parameter for the network event data field such that a higher frequency maps to a value indicating greater importance. In some examples, a particular selection parameter value may indicate an availability of the network event data field in the data storage facility. The availability may indicate presence of the data in the network event data field in the storage facility, or may indicate presence of the data in the network event data field in a particular storage function of the data storage facility. The particular storage function may comprise a function associated with particular read/write capabilities. The particular read/write capabilities may include a speed of read/write operations, and the particular storage function may comprise a short or medium term storage function (also referred to as Hot or Warm storage functions). The trained machine learning model may map the determined frequency to a value of the selection parameter such that a higher frequency maps to a selection parameter value associated with greater availability of the data in the network event data field.

The mapping step 320 may be performed according to the objective function:

$${Minimise}_{\vec{x}} \vec{c} \cdot \vec{x} \\ Subject to \frac{{\sum }_{q ∈ {Q}_{T}} g ( q , \vec{x} )}{\vert {Q}_{T} \vert} \geq C \\ Where g ( q , \vec{x} ) = \{ \begin{matrix}1 if A ( q ) - B ( \vec{x} ) = 0 , \\ 0 otherwise\end{matrix}$$

wherein:
\vec{c} comprises a vector of storage capacity occupied by network event data fields;

\vec{x} comprises a vector of selection parameter values for network event data fields;

Q_{T} comprises a set of queries submitted over an analysis time window T;

A(q) comprises a set of network event data fields required by a query q; and

B (\vec{x}) comprises the set of network event data fields having a particular selection parameter value according to \vec{x};

C comprises a threshold for queries for which the required network data event fields have the particular selection parameter value.

The particular selection parameter value may correspond to an availability of the data in the corresponding network event data fields, such that if A(q)−B(\vec{x})=0 for a particular query q, this indicates that all of the network event data fields that are required by query q are available according to the vector \vec{x}. Further discussion of the above objective function is provided below.

In step 332, the FFS engine generates a definitive value of the selection parameter by combining the frequency based value of the selection parameter with a static value of the selection parameter. The static value may be preconfigured for the network event data fields on the basis of at least one of legal requirements, regulatory requirements, business requirements etc. In one example, the selection parameter comprises a binary value, and combining the dynamic value of the selection parameter with a static value of the selection parameter comprises performing a logical OR operation on the dynamic value of the selection parameter and the static value of the selection parameter. In this manner, any network event data fields that are required to be maintained in a certain storage function for legal, regulatory or business reasons may be assigned a static value of the selection parameter of 1. The combination using a logical OR function will ensure that such network event data fields are always assigned a positive definitive value of the selection parameter, in addition to any network event data filed having a positive dynamic value of the selection parameter.

In step 324, the FFS engine generates a vector of selection parameter values for a plurality of network event data fields and in step 326, the FFS engine determines whether or not the generated vector of selection parameter values satisfies a criterion representing a threshold for queries for which the required network data event fields have a particular selection parameter value. The particular selection parameter value may be associated with availability of the data in the network event data fields, such that the criterion represents a threshold for queries for which the required network event data fields are available.

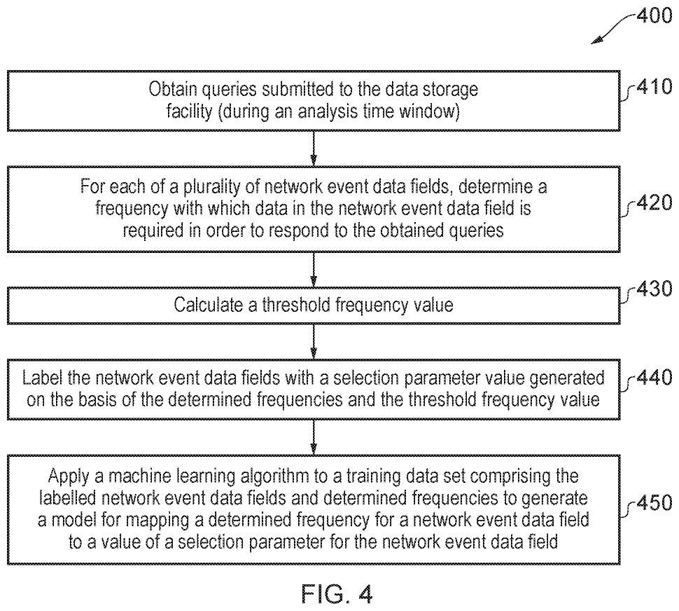

If the generated vector of selection parameter values does not satisfy the criterion, the FFS retraining the machine learning model in step 328 (as discussed below with reference to FIG. 4) and then returns to step 320 to use the retrained machine learning model to map the determined frequency vector to a dynamic value of a selection parameter for network event data fields.

If the generated vector of selection parameter values does satisfy the criterion, the FFS may perform any one or more of the three options illustrated in FIG. 3c. In first and second options, the FFS engine selects, at step 330, a storage function for a network event data field in accordance with the definitive value of the selection parameter with which it is associated. As discussed above, the storage functions may have particular read/write capabilities, and selection of a storage function in accordance with the selection parameter may comprise selecting a storage function having faster read/write capabilities for those network event data fields having a particular value of the selection parameter (the value being associated with a greater frequency of requirement for responding to obtained queries). Thus, in an example in which the selection parameter is a binary value, step 330 may comprise selecting a Warm or medium term storage function for a network event data field having a selection parameter value of 1, and selecting a Cold or long term storage function for a network event data field having a selection parameter value of 0. Once all network event data field have been considered, as checked in step 332, the FFS engine may, in a first option as illustrated in step 334, initiate storage of data in the different network event data fields in the selected storage function for each network event data field. In a second option, the FFS engine may check for occurrence of a migration trigger in step 336 and, on occurrence of the migration trigger, initiate migration of data in a network event data field to the selected storage function for the network event data field. In one example, the migration trigger may comprise expiry of the analysis time window.

In a third option, the FFS engine generates an overview selection parameter value by combining selection parameter values over a plurality of analysis time windows in step 340. In examples in which the selection parameter comprises a binary value, this may comprise performing a logical OR operation on the selection parameter values over the plurality of analysis time windows. This combination may ensure that only those network event data fields that have never had a positive selection parameter value during the plurality of analysis time windows not be assigned a positive value of the overview selection parameter, and so will be selected for deletion from the storage function in step 342 as discussed below. In some examples, the plurality of analysis time windows may be sufficient to ensure that the total time covered by the plurality of analysis time windows fulfils certain criteria applicable to a particular service or service provider. For example, the plurality of analysis time windows may be sufficient to ensure that the total time covered by the plurality of analysis time windows is at least one calendar year, so as to account for variations in the nature of queries that may be submitted over a year long period. In some examples, the total time covered by the plurality of analysis time windows may comprise between 1.5 and 2 years.

In step 342, the FFS engine determines whether to delete data in a network event data field from a storage function in the data storage facility on the basis of the overview selection parameter value. The FFS engine checks in step 344 whether all network event data fields have been considered and, if so, initiates deletion of data in the network event data fields in step 346 in accordance with the determination. The third option illustrated in steps 340 to 346 thus has the effect of purging from the storage function any data that has not been required to respond to a received query for a significant period of time (the plurality of analysis time windows), so avoiding the unnecessary incurring of storage cost for data that is not required.

In some examples of the method 300, migration of data between storage functions may be performed, for example on a periodic basis and in combination with or independently of the migration that may be performed in step 338 discussed above. This migration is illustrated in FIG. 3d, and concerns data in network event data fields that are stored in a storage function of the data storage facility that is associated with a first set of read/write capabilities. This may for example be Hot, Warm or Cold storage. In step 350, the FFS engine identifies data for migration to a storage function of the data storage facility that is associated with a second set of read/write capabilities on the basis of at least one of frequency of access requests, and storage capacity occupied by the data in the network event data fields. This may comprise preferentially identifying data having a highest or lowest frequency of access requests, and maximising a total storage capacity occupied by the identified data up to a maximum available storage capacity in the storage function of the data storage facility that is associated with the second set of read/write capabilities. In this manner, a maximum amount of data may be identified for migration, to occupy all available capacity in the destination storage function. The identified data may be data in fields that are most frequently accessed, for example if the data is to be transferred from Cold to Warm, or Warm to Hot storage, or may be data in fields that are least frequently accessed, for example if the data is to be transferred from Hot to Warm, or Warm to Cold storage. In step 352, the FFS engine initiates migration of the identified data to the storage function of the data storage facility that is associated with the second set of read/write capabilities.

FIG. 4 is a flow chart illustrating process steps in a method 400 for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions. The method 400 may be performed by any appropriate function or apparatus in or in communication with the telecommunication network. In some examples, the method may be performed by a FFS engine as discussed above. With reference to FIG. 4, in a first step 410, the method 400 comprises obtaining queries submitted to the data storage facility, for example during an analysis time window. In step 420, for each of a plurality of network event data fields, the method 400 comprises determining a frequency with which data in the network event data field is required in order to respond to the obtained queries. The method then comprises, in step 430, calculating a threshold frequency value and, in step 440, labelling the network event data fields with a selection parameter value generated on the basis of the determined frequencies and the threshold frequency value. In step 450, the method 400 comprises applying a machine learning algorithm to a training data set comprising the labelled network event data fields and determined frequencies to generate a model for mapping a determined frequency for a network event data field to a value of a selection parameter for the network event data field.

The selection parameter value may be binary and labelling the network event data fields may comprise setting the selection parameter value to 1 for all network event data fields having a frequency over the threshold frequency. In some examples, the method may comprise generating vectors of frequencies for time slots over an analysis time window, which may for example be a retention time for a storage function in the data storage facility. In other examples the vector may comprise frequencies for multiple analysis time windows.

According to some examples of the present disclosure, calculating a threshold frequency value may comprise generating a vector:

\vec{u}=[Σ\vec{v}⁽¹⁾,Σ\vec{v}⁽²⁾,Σ\vec{v}⁽³⁾, . . . ,Σ\vec{v}⁽ⁿ⁾],

in which \vec{v}⁽ⁱ⁾ comprises a vector of frequencies for a plurality of time slots within an analysis time window for a network event data field i, and calculating the threshold frequency value using the expression:

$${v}_{θ} = {argmin}_{v} \frac{\sum \{ u ∈ \vec{u} \vert u \geq v \}}{\sum \vec{u}} \geq C$$

in which v_{θ} comprises the threshold frequency value and C comprises a threshold for queries for which the required network data event fields have a particular selection parameter value.

In some examples, the method 400 may further comprise determining whether the generated model conforms to a constraint by generating a vector \vec{y} of mapped selection parameter values using the generated model and determining whether the generated vector satisfies the expression:

$$\frac{\vec{u} \cdot \vec{y}}{\sum \vec{u}} \geq C$$

The machine learning algorithm applied in step 450 may for example comprise at least one of a Random Forrest algorithm or a Logistic Regression algorithm.

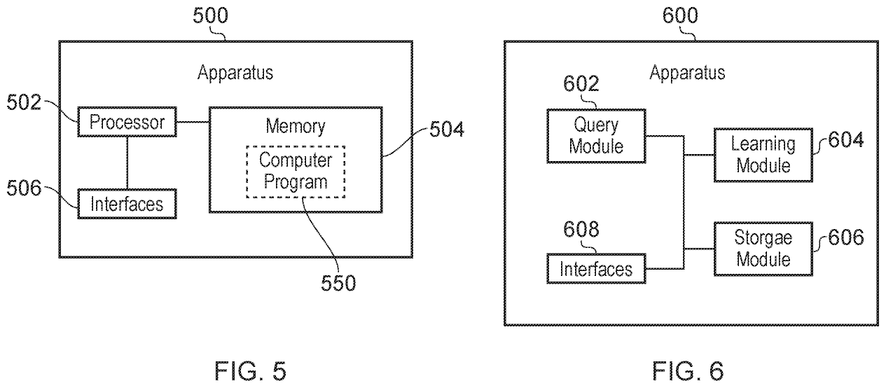

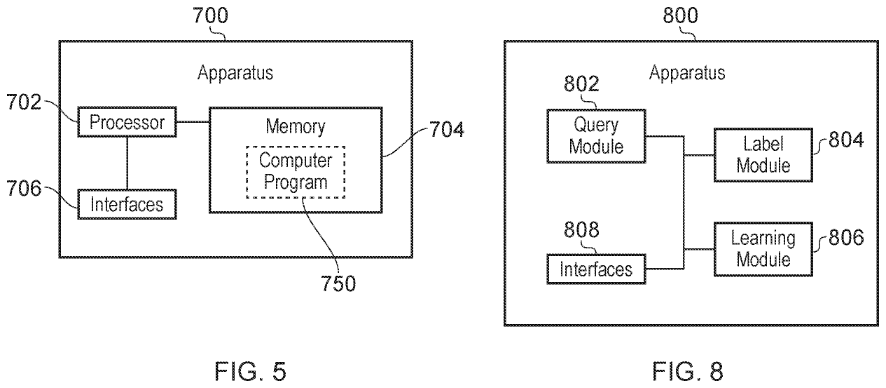

FIGS. 5 and 6 are block diagrams illustrating examples of apparatus 500, 600 which may carry out examples of the method 200 and or 300 as discussed above. The apparatus 500, 600 may for example comprise a FFS engine, as mentioned above and discussed in further detail below.

FIG. 5 illustrates a first example of apparatus 500, which may implement some or all of the steps of method 200 and/or 300 according to examples of the present disclosure, for example on receipt of suitable instructions from a computer program 550. The apparatus may for example be located in a server of or connected to a core network, a base station or other radio access node, or a server in a data center running one or more virtual machines executing the steps of the method 200 and or 300. Referring to FIG. 5, the apparatus 500 comprises a processor or processing circuitry 502, and may comprise a memory 504 and interfaces 506. The processing circuitry 502 is operable to perform some or all of the steps of the method 200 and/or 300 as discussed above with reference to FIGS. 2 and 3a to 3d. The memory 504 may contain instructions executable by the processing circuitry 502 such that the apparatus 500 is operative to conduct some or all of the steps of the method 200 and/or 300. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive etc.

FIG. 6 illustrates another example of apparatus 600, which may also be located in a server of or connected to a core network, a base station or other radio access node, or a server in a data center running one or more virtual machines executing the steps of the method 200 and or 300. Referring to FIG. 6, the apparatus 600 comprises a plurality of functional modules, which may execute the steps of method 200 and/or 300 on receipt of suitable instructions for example from a computer program. The functional modules of the apparatus 600 may be realised in any appropriate combination of hardware and/or software. The modules may comprise one or more processors and may be integrated to any degree. The apparatus 600 is for managing network event data in a telecommunications network, wherein a network event is associated with a plurality of network event data fields, and wherein the telecommunications network comprises a data storage facility for network event data, the data storage facility comprising a plurality of storage functions. The apparatus 600 comprises a query module 602 for obtaining queries submitted to the data storage facility and, for a network event data field, determining a frequency with which data in the network event data field is required in order to respond to the obtained queries. The apparatus 600 further comprises a learning module 604 for using a trained machine learning model to map the determined frequency to a value of a selection parameter for the network event data field. The apparatus 600 further comprises a storage module for performing at least one of storing data in the network event data field in a storage function in the data storage facility, migrating data in the network event data field between storage functions in the data storage facility, or deleting data in the network event data field from a storage function in the data storage facility, in accordance with the value of the selection parameter. The apparatus 600 also comprises interfaces 608.

FIGS. 7 and 8 are block diagrams illustrating examples of apparatus 700, 800 which may carry out examples of the method 400 as discussed above. The apparatus 700, 800 may for example comprise a FFS engine, as mentioned above and discussed in further detail below.

FIG. 7 illustrates a first example of apparatus 700, which may implement some or all of the steps of method 400 according to examples of the present disclosure, for example on receipt of suitable instructions from a computer program 750. The apparatus may for example be located in a server of or connected to a core network, a base station or other radio access node, or a server in a data center running one or more virtual machines executing the steps of the method 400. Referring to FIG. 7, the apparatus 700 comprises a processor or processing circuitry 702, and may comprise a memory 704 and interfaces 706. The processing circuitry 702 is operable to perform some or all of the steps of the method 400 as discussed above with reference to FIG. 4. The memory 704 may contain instructions executable by the processing circuitry 702 such that the apparatus 700 is operative to conduct some or all of the steps of the method 400. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive etc.

FIG. 8 illustrates another example of apparatus 800, which may also be located in a server of or connected to a core network, a base station or other radio access node, or a server in a data center running one or more virtual machines executing the steps of the method 400. Referring to FIG. 8, the apparatus 800 comprises a plurality of functional modules, which may execute the steps of method 400 on receipt of suitable instructions for example from a computer program. The functional modules of the apparatus 800 may be realised in any appropriate combination of hardware and/or software. The modules may comprise one or more processors and may be integrated to any degree. The apparatus 800 is for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions. The apparatus 800 comprises a query module 802 for obtaining queries submitted to the data storage facility and, for each of a plurality of network event data fields, determining a frequency with which data in the network event data field is required in order to respond to the obtained queries. The apparatus 800 further comprises a label module 804 for calculating a threshold frequency value and labelling the network event data fields with a selection parameter value generated on the basis of the determined frequencies and the threshold frequency value. The apparatus 800 further comprises a learning module 806 for applying a machine learning algorithm to a training data set comprising the labelled network event data fields and determined frequencies to generate a model for mapping a determined frequency for a network event data field to a value of a selection parameter for the network event data field. The apparatus 800 also comprises interfaces 808.

The following description provides additional detail as to how the above discussed steps of methods 200, 300 and 400 may be implemented, followed by a presentation of case studies.

As discussed above, aspects of the present disclosure allow flexibility in accommodating an evolving schema of network events and their data fields by treating the features of each field present in the schema as an individual sample. A learning outcome for a network event data field is achieved that comprises a single label which determines whether the field ought to be retained in a particular storage function or removed (set to null). The features for the learning model are the frequency of requests for the field over an analysis period T split over k equal sub-intervals or time slots t₁, t₂, t₃, . . . , tₖ. In some examples, only leaf fields in the schema are considered. A field is a leaf filed if it is neither an array nor a structure. Hence, String, Integer, Long, Boolean and Map are the considered types of fields. x denotes the n dimensional vector [x₁, x₂, x₃, . . . , xₙ]. Here n denotes the number of leaf fields and the binary variable xᵢ determines whether the field i is included (1) or not (0) in a particular storage function. cᵢ is the cost of the ith field which represents the space occupied by the field in a database. An objective is to minimise the number of fields A(q) required based on queries available in the database while answering at least a specified proportion of incoming queries Q_{T}, over a period of time T i.e., ascertain that at least C fraction of queries are answered. The optimisation objective function can be considered to be minimizing

f(x)=Σᵢ₋₁ⁿcixi

subject to the summation of the constraint function g(q, \vec{x}) where q represents the incoming query terms. f(x) can be represented as a dot product of two vectors \vec{c} and \vec{x}.

Q_{T}: Set of queries asked over a period T

A(q): Set of attributes required by the query q

B(\vec{x}): Set of attributes corresponding to \vec{x}

The optimization objective can now be represented as

$${minimize}_{\vec{x}} \vec{c} \cdot \vec{x} \\ subject to \frac{{\sum }_{q ∈ {Q}_{T}} g ( q , \vec{x} )}{\vert {Q}_{T} \vert} \geq C \\ where g ( q , \vec{x} ) = \{ \begin{matrix}1 if A ( q ) - B ( \vec{x} ) = ∅ , \\ 0 otherwise\end{matrix} \qquad ( 1 )$$

A Frequent Field Selection (FFS) algorithm, for example running in an FFS engine as discussed above, optimises the above objective by taking the frequency of query requests for each field into account. The frequency vector of a field i is \vec{v}⁽ⁱ⁾=[v₁⁽ⁱ⁾, v₂⁽ⁱ⁾, v₃⁽ⁱ⁾, . . . vₖ⁽ⁱ⁾)] where vⁱⱼ is the frequency of requests received for the ith field within the jth time slot. The trained machine learning model of methods 200 and 300 provides a mapping function h:R^{k}→Z₂, where Z₂=0, 1 denotes whether the field corresponding to the frequency vector, \vec{v}, is included or not in a particular storage function. Z₂ thus represents the selection parameter of methods 200, 300, 400. An assumption may be made that by selecting a set of attributes corresponding to C proportion of attribute request frequency, C proportion of query requests will be satisfied, as discussed above.

In order to train the model, an initial set of records is labeled using a threshold. A sample is accepted (given a positive selection parameter label) if its cumulative frequency, Σ\vec{v}, is greater than the threshold frequency, v_{θ}. To define v_{θ}, a vector \vec{U} is defined that is composed of the sum of each i as follows.

\vec{u}=[Σ\vec{v}⁽¹⁾,Σ\vec{v}⁽²⁾,Σ\vec{v}⁽³⁾, . . . ,Σ\vec{v}⁽ⁿ⁾],

The threshold frequency can be calculated as:

$${v}_{θ} = {argmin}_{v} \frac{\sum \{ u ∈ \vec{U} \vert u \geq v \}}{\sum \vec{U}} \geq C \qquad ( 2 )$$

In an implementation, the threshold may be labeled for each period, and the model accuracy may be periodically evaluated to see whether the constraint is respected. \vec{y}=[y⁽¹⁾, y⁽²⁾, y⁽³⁾, . . . , y⁽ⁿ⁾] denotes the predicted label vector, where y⁽ⁱ⁾=h(\vec{v}⁽ⁱ⁾). To evaluate whether the model has deviated from the set constraint, the constraint may be formulated in terms of the frequency of field requests as follows:

$$\frac{\vec{U} \cdot \vec{y}}{\sum \vec{U}} \geq C \qquad ( 3 )$$

Each time this constraint is violated, the threshold, v_{θ} may be recomputed and the model may be trained with the current state of the system. In practice, it is likely that the threshold will only be violated if the value of the constraint proportion C is altered. In one example, \vec{v} is a sliding window with a fixed window size, k. When the demand for an arbitrary field changes, the change is therefore reflected immediately in the vector \vec{v} and the model accepts it according to the trained hypothesis.

It will be appreciated that not all of the attributes that are important are frequently queried. A set of attributes P may be defined that are required by legal authorities, financial accountants and business analysts. The frequencies corresponding to these attributes are negligible compared to that of the queries pertaining to customer requests. However, the necessity of such attributes are not stochastic as in the case of customer-related attributes. That is, the attribute set P can be predetermined and would not require a model to predict its importance. This characteristic of certain attributes may be accommodated by the use of dynamic and static values of the selection parameter. If yₚ is the vector denoting the set of attributes, P, that should be permanently selected for migration, and yₜ is the test vector produced by the trained model, then the final field selection vector can be the disjunction (logical OR) of yₜ and yₚ, i.e., y=yₚVyₚ.

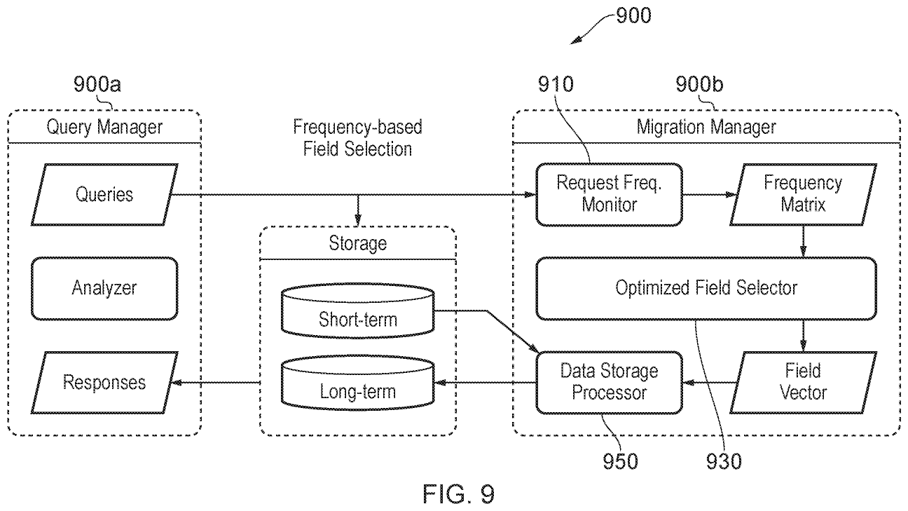

An architecture for the apparatus implementing the FFS algorithm is discussed below and illustrated in FIG. 9. Such an architecture may be incorporated into any of the apparatus 500, 600, 700, 800 discussed above.

A typical storage architecture for a telecommunication system makes use of an Application Programming Interface (API) to access the storage database by converting a request to queries, analyzing query responses and producing the necessary inputs for the calling program. This API module is referred to as a query manager 900a. The query manager is the interface between the business logic functions and the storage database. The architecture 900 also comprises a migration manager 900b, which listens to all queries sent from the query manager 900a to the storage. The migration manager 900b extracts the attributes required to respond to each query and assesses their frequency to compute a model that produces the subset of attributes selected for migration to long-term storage (archival), to medium term storage, for deletion from storage etc.

The migration manager 900b comprises three main components: a Request frequency monitor 910, an Optimized field selector 930, and a Data storage processor 950. The frequency monitor 910 feeds the frequency matrix to be processed by the field selector 930. The field selector 930 considers the fields that have a greater frequency to be important and creates a vector that encompasses these fields based on a programmed critique. The storage processor 950 periodically initiates the migration operation to back up only those fields as provided by the field selector 930 from one storage function to another, for example from the short-term storage to the long-term storage.

### Request Frequency Monitor

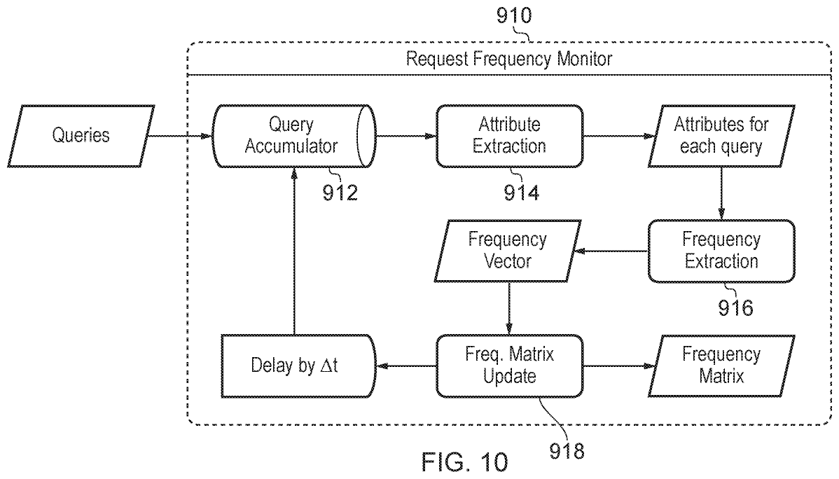

As described above, the analysis time period T is split to k time slots, each of size Δt. The request frequency monitor 910, illustrated in greater detail in FIG. 10 first accumulates queries over Δt in a query accumulator 912. It then extracts the attributes required to process and respond to each query in an attribute extraction module 914. The frequency of requests for each attribute over the time slot is computed in a frequency extraction module 916 to produce a frequency vector. This vector updates the frequency matrix in a frequency matric update module 918 by becoming the first column of the matrix and shifting the remaining columns one space to the right. This process is repeated for each passing Δt. Initially, the matrix is populated with null columns; one new column is added for every Δt. The matrix is considered to be complete when all its k columns are populated, after which the updated frequency matrix is passed to the field selector 930 for every iteration.

### Optimised Field Selector

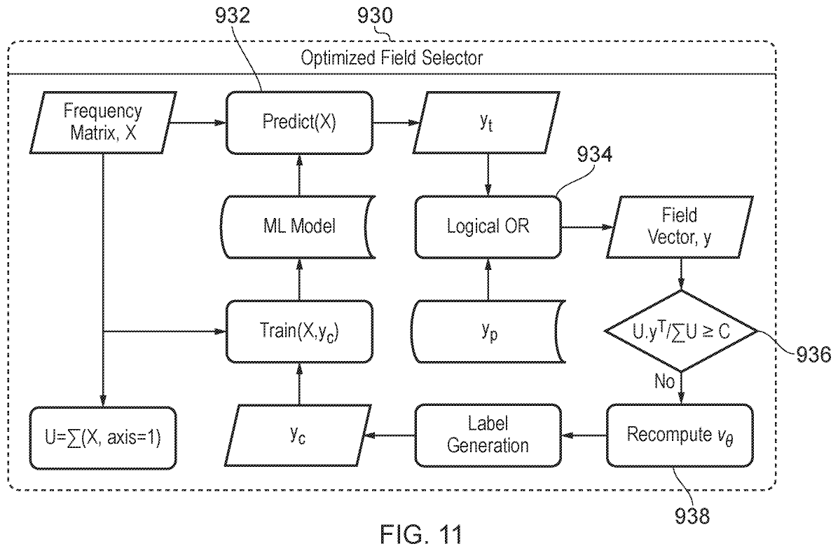

The optimized field selector 930 is illustrated in FIG. 11 and is initialised by training the Machine Learning (ML) model with the first complete frequency matrix from the frequency monitor 910. The training labels are obtained based on the frequency threshold, v_{θ}, from Equation 2 above. The training label is 1 (inclusion) if the corresponding index of the vector U is greater than or equal to v_{θ} and is 0 (exclusion) otherwise. This training label is called y_{c} as it is computed from the threshold which is based on the set constraint, C. Once the model is initialised, it predicts 932 the importance of each field of the frequency matrix for each passing Δt. The predicted field vector yₜ (based on a dynamic value of the selection parameter) is merged with the permanent field vector yₚ (based on a static value of the selection parameter) through a logical OR operation 934 to form the output field vector, \vec{y}. If this vector satisfies the constraint 936 as specified in Equation 3, the vector is passed through to the storage processor. Otherwise, the threshold is recomputed 938, the model is updated, and a new field vector is produced to satisfy the condition and is then sent to the storage processor.

### Data Storage Processor

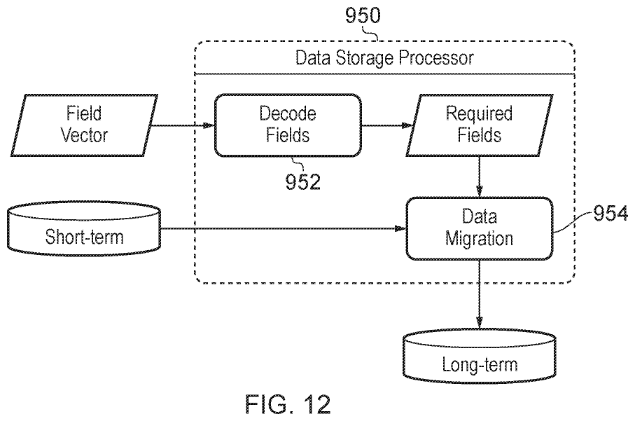

In an existing system, data is periodically backed up from the short-term storage to the long-term storage for every fixed time frame, which can vary between months to just over a year. In the proposed FFS architecture, the storage processor 950, illustrated in FIG. 12, accumulates 952 the required fields over this time frame and then migrates 954 those fields from the short-term storage to the long-term storage once the transfer is initiated.

Data Migration Process within Different Storage Functions

The migration of the optimised event data may be dynamically orchestrated between the different storage options i.e. transferred between short-term storage (Hot/Warm) with fast read/write capabilities and long-term storage (Cold) based on the frequency of access. If the optimised event data in the cold storage is frequently accessed, then it may be moved to the Hot/Warm storage. This migration management may be performed using the algorithm below:

Let Eᵢ=>Sorted Ranked Frequency of optimized event access in the cold storage
Sᵢ=>Size of storage required relate to event
Max=>Calculated Space available in the Hot/warm cluster
Cr=>Criteria for movement
n=>number of records in a batch
Th=>minimum chunk size

U is function mapping from event frequency into size of event required. U(Eᵢ)=Sᵢ where 1<=i<=n and newly defined objective function is
Max Sⱼ,
   Subject to

Th<=Sⱼ<=Max

ΣU(Eⱼ) where
1<j<=n

Depending the type of sort, event access frequency (Ei) will be arranged in either ascending or descending order and related to this the data migration can be initiated from cold to hot/warm storage function or hot/warm to cold storage function. The example below illustrates data migration implementation from Cold to Hot/warm storage functions in storage systems.

| | Access Frequency count | | | |
|---|---|---|---|---|
| Event | (Ei) | Size(Kb) (Si) | | |
| Event1 | 10 | 4 | | |
| Event2 | 15 | 10 | | |
| Event3 | 20 | 30 | | |
| Event4 | 40 | 20 | | |
| Event5 | 30 | 10 | | |
| Event6 | 15 | 40 | | |
| Event7 | 5 | 30 | | |
| Event8 | 7 | 25 | | |
| Event9 | 1 | 35 | | |
| Event10 | 0 | 15 | | |
| Sr | Calculated reserved | 80 | Kb | |
| | Space available in Hot or | | | |
| | Cold or Warm depending | | | |
| | on direction of migration | | | |
| Th | Minimum chunk size | 40 | Kb | reduce the copy |
| | | | | load |
| | | | | Less than 80 Kb |
| Cr | Criteria for movement is | Event4 + Event5 | 30 | FALSE |
| | dependent on iterative | | | |
| | sum of event size | | | |
| | | “Event 4 + Event | 70 | FALSE |
| | | 5 + Event3 + Event2” | | |
| | Exit and not moved | “+Event6″ | 115 | TRUE |

So Event4, Event5, Event3, Event2 to be moved in two steps of 40 Kb each
to Hot/warm

The following case studies illustrate example implementations of the methods and apparatus presented in this disclosure.

### Case Study 1 (Illustrated in FIG. 13):

In the next generation charging system, telecommunication data is maintained in different databases. These databases are governed by an Event Processing Stack (EPS). The EPS is managed by an Event Data Management (EDM) server cluster 1304 in a Revenue Manager (RM). The telecommunications data mostly consists of Usage Charge Events as well as other events including Balance Adjustment, Refill, Order management etc. The schema of these events has a complicated tree-like structure in which the leaves are predominantly strings. For illustration, the schema of the UsageChargeEvent event is considered. This is an event generated by the charge server (CHA) 1306 of the Revenue Manager framework. This event has 357 fields in total including nested structures and arrays, out of which 240 are leaf fields. The number of time slots is k=20. Only the leaf attributes are considered for selection. Intermediate nodes are removed from the model to avoid confusion. It can be inferred that if a child node is included, so will be the corresponding parent node. The dimension of the frequency matrix is hence 240 samples with 20 features each. The features are all positive integers (frequency counts for the time slots). As the patterns to be learned are not complicated, deep learning frameworks are not required for building the model. The machine learning model used in in the present case study is a Random Forest classifier with 10 trees. The constraint set here is C=0:9, i.e., at least 90% of the requests are to be satisfied on archive. As the query database is unavailable, the outcome of the frequency monitor is generated by a driver for this illustration. The driver is given a probability for each field and the frequency monitor driver then produces frequencies periodically according to the probability assigned and delivers those frequencies to the field selector. As the hypothesis space is relatively simple for this function, the training can be completed by accounting just five periods where each period, T, contains 240 samples (corresponding to 240 fields). Thus, a total of 1200 samples is used for the initial training step, which should be sufficient to converge to the required hypothesis. During the update phase, the critique provides the target y_{c} to train the field selector.

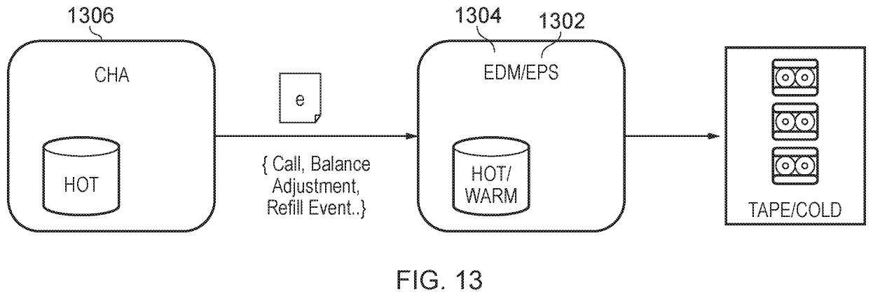

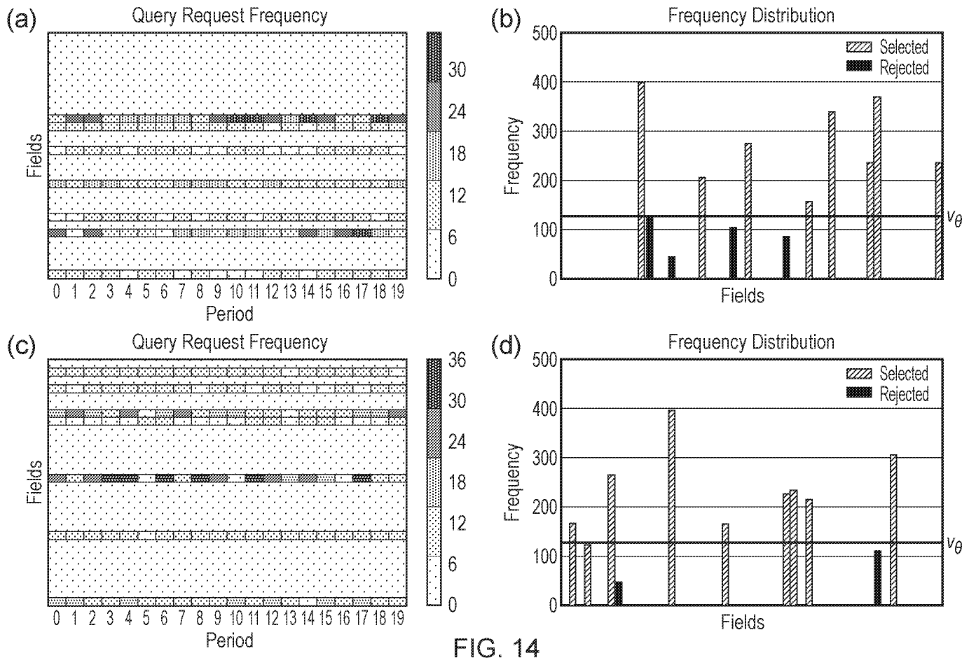

FIG. 14 illustrates operation of the FFS engine considering only the first 50 fields for clarity. FIG. 14a illustrates the initial frequency matrix, X, represented as a heat map. FIG. 14b illustrates the initial frequency distribution over period, T, i.e., value of the summation vector, U for training. FIG. 14c illustrates the frequency matrix after changing in frequency pattern and FIG. 14d illustrates the corresponding U after model application.

Over the lifetime of the charge events, only a few fields will have a considerably high query frequency, some others may have lesser requests and most would not be queried at all. For this illustration, the frequency matrix is initially populated as shown in FIG. 14a (with only the first 50 fields included for clarity). The summation vector, U, depicts the frequency distribution over the period, T. After v_{θ} is computed, all values of U that are greater than v_{θ} are labeled selected for migration. The remaining fields would not participate in the migration and hence are considered rejected. This labeling is applied initially for training as shown in FIG. 14b, after which v_{θ} may be discarded as it is the model that will determine which fields to select. Considering a scenario in which the customer query pattern changes as shown in FIG. 14c, different fields may become frequently queried fields while the previously useful fields might become obsolete. In such scenarios, the model will still behave rationally considering the most frequent field as per the current scenario. From FIG. 14d it can be observed that the model has selected fields corresponding to the threshold with which it was trained.

Another phenomenon can also be observed from FIG. 14d: the second field, despite being just below the threshold v_{θ}, is accepted. The model has observed the potential of this field to become an important field and marked it for migration. That is, the model implicitly sets a threshold with a tolerance based on the observed query frequency pattern. Therefore, even when the structure of the schema changes, or when the demand for a field changes, the model need not be retrained. An update phase occurs only when the threshold frequency, C, is altered or a change in the cumulative query frequency is observed. To make the system invariant of the cumulative frequency, normalized frequency values can be fed to the field selector per period.

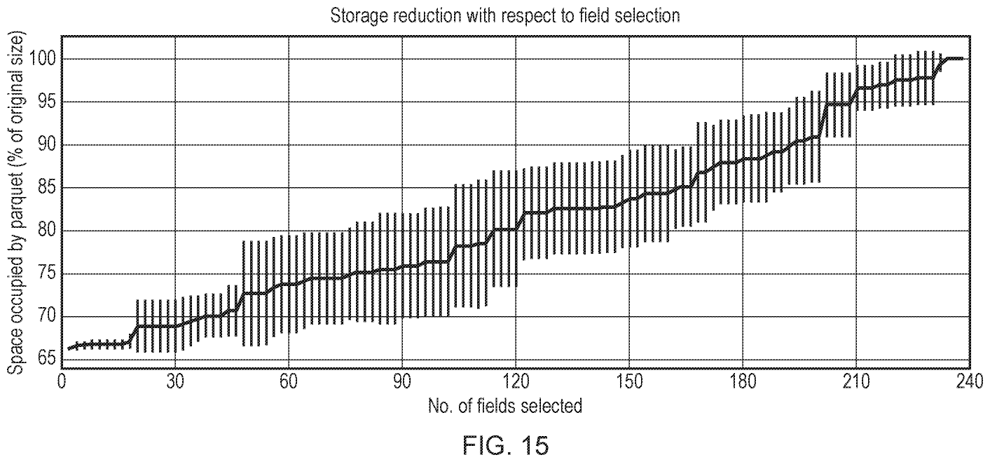

FIG. 15 illustrates storage efficiency of example methods according to the present disclosure, as illustrated in the above case study. FIG. 15 shows the reduction in required storage space when a subset of the 240 fields are selected. As it is difficult to know how many fields would be just right to satisfy C for each customer, the graph of FIG. 15 shows the amount of space reduced when a set number of fields are selected. For this case study, a parquet file containing all fields of the UsageChargeEvent is taken as a reference and the number of fields n ranges between 2 to 238 in increments of 2. In each step, 5 random sets of n fields are selected and stored as a parquet and the ratios between the reduced files and the original file are calculated. The line on the graph represents the mean average of 5 runs and the error bars depict the standard deviation for each value of n. It will be noted that even when just two fields are selected, the size of the corresponding parquet file is just above 65% of the original parquet size. This peculiarity is due to the efficient compression by Apache Parquet. One cause for this phenomenon is the ability of the parquet to reuse the encoding dictionaries produced for each additional column it encounters. For example, if FFS selects only 90 leaf fields for migration, then the migrated storage space would range between 70% and 83% of the size it would have occupied without the feature selection applied. In this case, for a database table whose archival size is 14 TB, 2.38 to 4.2 TB of space (20% to 25%) can be saved by applying FFS if only 100/240 fields are required.

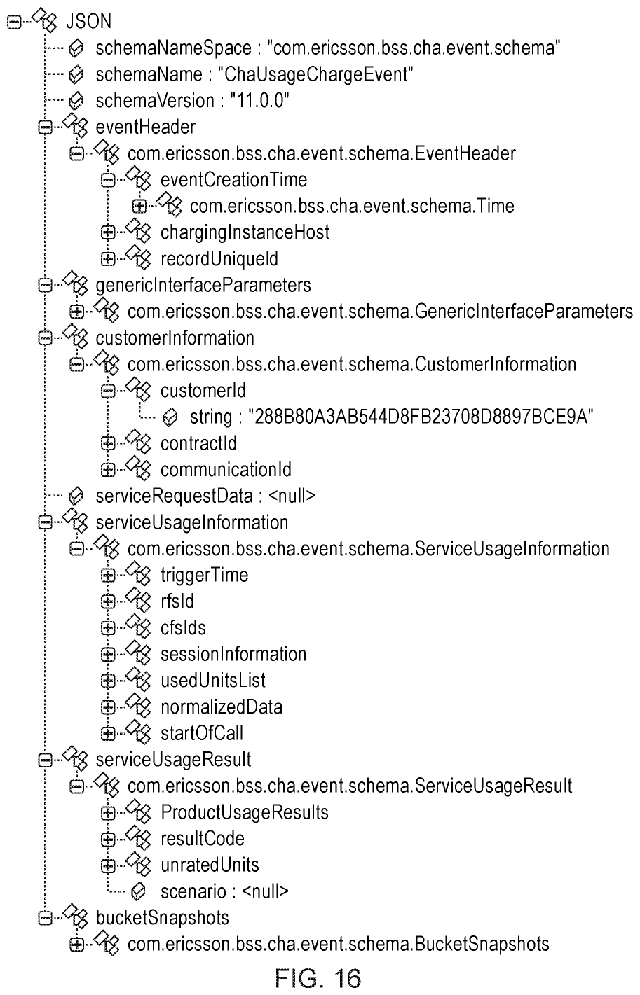

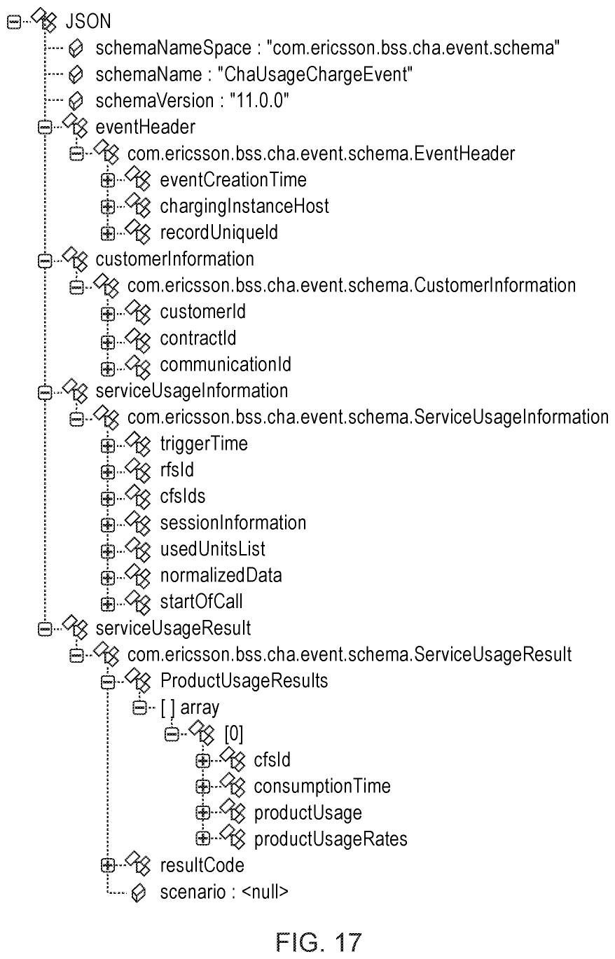

Case Study 2 (Illustrated in FIGS. 16 and 17):

FIG. 16 shows a sample usage event which contains many attributes, is generated by a voice call scenario and is represented in JSON. The size of the event in JSON format is 8140.8 KB

FIG. 17 shows the same event after applying the FFS algorithm as described aboveError! Reference source not found. The size of the event after applying FFS (with a value of C=95% satisfaction of queries) is 6563.8 KB. This equates to a total reduction of required storage of approximately 20%. FIGS. 16 and 17 thus demonstrate the efficiency of examples of the methods disclosed herein in reducing storage requirements and so saving cost. In addition, query response speed was improved by 25%.

Examples of the present disclosure thus provide methods and apparatus that facilitate the selection of an optimal subset of fields from a schema, based on the frequency with which queries that require those fields are submitted. The fields may be selected such that an agreed proportion of queries are satisfied. In this manner, storage of telecommunications network data in Hot/Warm/Cold storage can be optimised, with reduced overall storage requirements and faster query response. Example methods of the present disclosure are adaptive in that the model can adapt to changes in the structure of the schema as well as to changes in the demand for different data fields. Also proposed are data migration methods according to which optimised event frequency selection and properties of storage clusters are taken into account to select data for migration between storage functions. Selection of a suitable analysis time window T and time slot Δt can be performed on consideration of a customer query database, as these parameters may be tailored to the nature of the query demands and the extent to which their evolution over time is erratic or structured.

Examples of the present disclosure offer a reduction in TCO for long term storage of network event data, by reducing the storage of data that is never accessed by the operator, and is therefore unnecessary. By optimising the selection of network event data fields for inclusion in Warm storage, the demand for such storage can be reduced, enabling data in the selected network event data fields to be maintained in the Warm storage, and hence more easily available for query resolution, for a longer period of time. Consequently, overall response time for queries is reduced, as a greater proportion of the data required for query resolution is maintained in Warm storage, where it is more easily and quickly accessible.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing network event data in a telecommunications network, wherein a network event is associated with a plurality of network event data fields, and wherein the telecommunications network comprises a data storage facility for network event data, the data storage facility comprising a plurality of storage functions, the method comprising:
obtaining queries submitted to the data storage facility; and
for a network event data field;
determining a frequency with which data in the network event data field is required in order to respond to the obtained queries;
using a trained machine learning model to map the determined frequency to a value of a selection parameter for the network event data field; and
performing at least one of:
storing data in the network event data field in a storage function in the data storage facility;
migrating data in the network event data field between storage functions in the data storage facility; or
deleting data in the network event data field from a storage function in the data storage facility, in accordance with the value of the selection parameter.

2. The method of claim 1, wherein
obtaining queries submitted to the data storage facility comprises obtaining queries submitted during an analysis time window comprising a plurality of time slots, and
wherein determining a frequency with which data in the network event data field is required to respond to the obtained queries comprises:
for a time slot in an analysis time window:
accumulating obtained queries submitted within the time slot;
extracting network event data fields required to respond to the accumulated queries; and
adding the number of times the network event data field appears in the extracted network event data fields to a time slot frequency count for the network event data field.

3. The method of claim 2, wherein determining a frequency with which data in the network event data field is required to respond to the obtained queries further comprises:
assembling time slot frequency counts for the network event data field from time slots in the analysis time window into a frequency vector for the network event data field during the analysis time window.

4. The method of claim 1, wherein
the selection parameter value indicates a relative importance of the network event data field with respect to responding to queries submitted to the data storage facility, and
wherein the trained machine learning model maps the determined frequency to a value of the selection parameter for the network event data field such that a higher frequency maps to a value indicating greater importance.

5. The method of claim 1, wherein using a trained machine learning model to map the determined frequency to a value of a selection parameter for the network event data field comprises:
using the trained machine learning model to map the determined frequency to a dynamic value of the selection parameter; and
generating a definitive value of the selection parameter by combining the frequency based value of the selection parameter with a static value of the selection parameter.

6. The method of claim 5, wherein
the selection parameter comprises a binary value, and
wherein combining the dynamic value of the selection parameter with a static value of the selection parameter comprises performing a logical OR operation on the dynamic value of the selection parameter and the static value of the selection parameter.

7. The method of claim 1, wherein the trained machine learning model is trained to map the determined frequency to a selection parameter for the network event data field according to the objective function:
$${Minimise}_{\vec{x}} \vec{c} \cdot \vec{x} \\ Subject to \frac{{\sum }_{q ∈ {Q}_{T}} g ( q , \vec{x} )}{\vert {Q}_{T} \vert} \geq C \\ Where g ( q , \vec{x} ) = \{ \begin{matrix}1 if A ( q ) - B ( \vec{x} ) = 0 , \\ 0 otherwise\end{matrix}$$
wherein:
\vec{c} comprises a vector of storage capacity occupied by network event data fields;
\vec{x} comprises a vector of selection parameter values for network event data fields;
Q_{T} comprises a set of queries submitted over an analysis time window T;
A(q) comprises a set of network event data fields required by a query q; and
B(\vec{x}) comprises the set of network event data fields having a particular selection parameter value according to \vec{x};
C comprises a threshold for queries for which the required network data event fields have the particular selection parameter value.

8. The method of claim 7, wherein the particular selection parameter value indicates an availability of the network event data field in the data storage facility.

9. The method of claim 1, wherein storing data in the network event data field in a storage function in the data storage facility in accordance with the selection parameter comprises:
selecting a storage function for the network event data field in accordance with the selection parameter; and
initiating storage of data in the network event data field in the selected storage function.

10. The method of claim 1, wherein migrating data in the network event data field between storage functions in the data storage facility in accordance with the selection parameter comprises:
selecting a storage function for the network event data field in accordance with the selection parameter; and
on occurrence of a migration trigger, initiating migration of data in the network event data field to the selected storage function.

11. The method of claim 2, wherein
migrating data in the network event data field between storage functions in the data storage facility in accordance with the selection parameter comprises: selecting a storage function for the network event data field in accordance with the selection parameter; and, on occurrence of a migration trigger, initiating migration of data in the network event data field to the selected storage function, and
the migration trigger comprises expiry of the analysis time window.

12. The method of claim 1, wherein deleting data in the network event data field from a storage function in the data storage facility in accordance with the selection parameter comprises:
generating an overview selection parameter value by combining selection parameter values over a plurality of analysis time windows; and
determining whether to delete data in the network event data field from a storage function in the data storage facility on the basis of the overview selection parameter value.

13. The method of claim 12, wherein
the selection parameter comprises a binary value, and
combining selection parameter values over a plurality of analysis time windows comprises performing a logical OR operation on the selection parameter values over a plurality of analysis time windows.

14. The method of claim 1, further comprising:
generating a vector of selection parameter values for a plurality of network event data fields; and
determining whether the generated vector of selection parameter values satisfies a criterion representing a threshold for queries for which the required network data event fields have a particular selection parameter value.

15. The method of claim 14, further comprising:
retraining the machine learning model as a result of determining that the generated vector of selection parameter values does not satisfy the criterion; and
using the retrained machine learning model to map the determined frequency to a value of a selection parameter for the network event data field.

16-25. (canceled)

26. An apparatus for managing network event data in a telecommunications network, wherein a network event is associated with a plurality of network event data fields, and wherein the telecommunications network comprises a data storage facility for network event data, the data storage facility comprising a plurality of storage functions, the apparatus comprising a processor and a memory, the memory containing instructions executable by the processor such that the apparatus is configured to:
obtain queries submitted to the data storage facility; and
for a network event data field:
determine a frequency with which data in the network event data field is required in order to respond to the obtained queries;
use a trained machine learning model to map the determined frequency to a value of a selection parameter for the network event data field; and
perform at least one of:
storing data in the network event data field in a storage function in the data storage facility;
migrating data in the network event data field between storage functions in the data storage facility; or
deleting data in the network event data field from a storage function in the data storage facility, in accordance with the value of the selection parameter.

27-29. (canceled)

30. An apparatus for training a machine learning model for use in a method for managing network event data in a telecommunications network, wherein a network event is associated with a plurality of network event data fields, and wherein the telecommunications network comprises a data storage facility for network event data, the data storage facility comprising a plurality of storage functions, the apparatus comprising a processor and a memory, the memory containing instructions executable by the processor such that the apparatus is configured to:
obtain queries submitted to the data storage facility;
for each of a plurality of network event data fields, determine a frequency with which data in the network event data field is required in order to respond to the obtained queries;
calculate a threshold frequency value;
label the network event data fields with a selection parameter value generated on the basis of the determined frequencies and the threshold frequency value; and
apply a machine learning algorithm to a training data set comprising the labelled network event data fields and determined frequencies to generate a model for mapping a determined frequency for a network event data field to a value of a selection parameter for the network event data field.

31-33. (canceled)
